(19) United States
(12) Patent Application Publication
(10) Pub. No.: US 2015/0192107 A1
(43) Pub. Date: Jul. 9, 2015

(54) Constant Power, Helical Transverse-Axis Wind Turbine with Automated Variable Pitch, Variable Radius and Torque Control

(71) Applicant: SequestraPower, Ltd, Bedford (GB)

(72) Inventor: Kevin Alexander Paul Kirchman, Bedford (GB)

(73) Assignee: SEQUESTRAPOWER, LTD, Bedford (GB)

(21) Appl. No.: 14/664,895

(22) Filed: Mar. 22, 2015

(51) Int. Cl. F03D 7/06; F03D 11/04; F03D 9/00; F03D 3/06; F03D 3/00

(52) U.S. Cl. CPC F03D 7/06; F03D 3/061; F03D 3/005; F03D 9/002; F03D 9/001; F03D 11/04; F05B 2240/95

(57) ABSTRACT

A transverse-axis power turbine, such as a Vertical-Axis Wind Turbine (VAWT), which includes both computer-controlled variable pitch and variable radius aspects providing a means to optimize performance and match variable loads in real-time. When multiple units are established coaxially and fixed to a floating platform, a method is presented of producing near net zero torque from the turbines on the floating platform. The transverse-axis power turbine can utilize helical blades for improved performance, while still benefiting from the variable radius and variable pitch functionality.

### CROSS-REFERENCE TO RELATED APPLICATIONS

This application claims the benefit of U.S. Provisional Patent Application 61/968,390, filed on Mar. 21, 2014; U.S. Provisional Patent Application 61/968,393, filed on Mar. 21, 2014; U.S. Provisional Patent Application 61/968,397, filed on Mar. 21, 2014; U.S. Provisional Patent Application 61/968,399, filed on Mar. 21, 2014; and U.S. Provisional Patent Application 61/968,401, filed on Mar. 21, 2014, all five by the present inventor, which are incorporated herein by reference.

### FIELD OF THE INVENTION

This invention relates to transverse-axis turbines, such as Vertical-Axis Wind Turbines (VAWTs), used for power generation, more particularly for automatically varying and optimizing the radius, blade pitch, torque control for floating applications, and power output of transverse-axis turbines at all fluid flow speeds using computer control.

### BACKGROUND OF THE INVENTION

As renewable energy becomes more important as a source of energy, variations on alternative designs that might facilitate significant increases in performance over tried designs, yet at lower production costs, provide commercial opportunity.

Previous VAWTS sought to reduce the radius of a turbine in order that it might continue to operate at higher wind speeds, when fixed radius turbines must be shut down. VAWTs are known to operate at lower wind speeds than Horizontal-Axis Wind Turbines (HAWTs), with a wider operating range, and produce power at a slower speed, thus reducing noise and threat to birds.

Problems with prior art include using inefficient variable radius types of turbines, inadequate performance when in an extended position, incapacity to utilize variable-radius devices with more efficient transverse-axis turbines, inability to fully withdraw the variable radius or utilize drag braking, weak structural design, or combinations of these failings.

In addition, there is no known prior art turbine of the variable radius transverse-axis type that has provided a method of torque control to be used on a floating offshore platform, which is required when a VAWT is used, which is preferred over other devices because its lower center of gravity results in a lower cost platform.

### PRIOR ART

The prior art includes numerous patents on wind turbines, both Horizontal-Axis Wind Turbines (HAWTs), and Vertical-Axis Wind Turbines (VAWTs). As the present device has the construction of the latter, as a member of the class of transverse-axis turbines, only VAWTs are referenced, some of which are:

Farb et al in WO2013/008200 A1 disclose a diameter modified for a Savonius VAWT, where the diameter is changed by changing the angle as looked at from overhead for a VAWT with vertical Savonius blades, or uses in claim 3 an expandable or retractable arm. The Savonius VAWT is not as efficient as Helical H-Rotor VAWTs, and thus this approach is not relevant as the Savonius blades have a different configuration which does not apply.

Vida Marques in U.S. Pat. No. 7,766,601 discloses a VAWT with blades that move radially on sliders, but remain at an angle, where the full length of the blade is unable to harvest the maximum energy when fully extended.

Yan in US2009196753A1 discloses a VAWT the diameter of which changes because of a hinge oriented vertically in the supports of the turbine blades, which is different to the present invention. This invention does not allow the radius to be changed by an automated control system, or according to other variables such as load matching. It is not practical for a helical VAWT design, which is more efficient and delivers a more constant power output during each revolution of the turbine.

Vari in WO/1984/004362 discloses a VAWT with a variable diameter where the diameter is modified by the use of a telescopic extension on the turbine blade support members, again a different mechanism than the present invention. The telescopic device sets limits to its inward travel, which means in marine use, as suggested, or land use, the turbine cannot be furled as completely, and the power output thus lowered. This device also does not create additional drag in the inward position, which is valuable for speed control in high winds.

Yum in U.S. Pat. No. 4,624,624 discloses a VAWT which has a hinge in the turbine blade itself for regulating the power output in various winds. This device is collapsible, but suffers from the turbine blades always being at an angle from the vertical, reducing the output of the turbine significantly when fully extended.

Griffen Jr. et al U.S. Pat. No. 5,083,901, the inventor shows a variable radius VAWT that uses slides rather than linkages, which differs from the present invention. The Griffen et al device does not function for a helical VAWT, which provides smoother output during its revolution, and better self-starting capability.

Herbertsson et al in U.S. Pat. No. 8,459,937 show a scissor-type wind turbine that does not contain helical blades, and the blades are formed from the struts, not separate blades at the ends of the scissors, as in one instance of the present invention. This design suffers from non-vertical blades, which are thus much less productive when extended. The scissor-type blade is weak as a structural design.

In Sullivan U.S. Pat. No. 4,500,257, the inventor shows the use of spoilers on a Darius turbine to affect variable power output, but this is unlike the present invention. This device does not minimize the radius for applications where that is essential.

Cousineau in U.S. Pat. No. 5,278,773 where the inventor presents a device and method of control, employing data collection and a distributed microprocessor control paradigm, but no general method by which the invention's advantages are utilized. This invention is no longer necessary, as single computer processing power has grown exponential since that patent's award.

Gelhard in WO03089787 has a floating wind platform with two Gelhard Rotors, which the present device does not use, which regulates the speed of the two separate turbine systems in the device. However it is not the speed that must be regulated to maintain the stability of the platform, so this invention is not functional in its efforts.

In summary, there is no known prior art that produces a high productivity at maximum extension, allows pitch control, or can be radius-reduced capably for a helical transverse-axis turbine, in a fully-automated manner, nor one which can be used offshore on a floating platform without applying a constant rotational force to its platform.

### BRIEF SUMMARY OF THE INVENTION

A novel aspect of the present invention is a device for maintaining a constant power output of a Vertical Axis Wind Turbine (VAWT) by varying the radius of the turbine blades on the unit for different wind velocities using a computer-controlled feedback mechanism. This aspect also allows the VAWT to “furl” its blades, for use in extreme wind conditions, where less power output is required for other reasons, or when a narrower radius for physical reasons (such as when on a floating vessel in port) is needed.

Because new technologies allow the conversion of electrical or hydraulic energy from a turbine into gaseous or liquid hydrocarbon fuel, for instance from chemically combining air captured carbon dioxide with hydrogen produced by electrolysis, too much power can be as problematic as too little. These power-to-fuel technologies, combined with the simultaneous direct electricity needs of a turbine power user, require a variable power output that can be practically and safely delivered. Thus a device and method for load-matching a variable power requirement is commercially valuable.

For instance, the equipment for power-to-fuel technologies is expensive. If these are rated for a particular turbine's maximum output, then too much cost will have been endured because of the low-percentage of time the turbine is operating at maximum output conditions.

Lowering the maximum output of a turbine by decreasing the radius of the turbine blades provides an effective means of reducing a VAWT's output during higher winds. This allows a larger incident wind-area for lower wind speeds, to maintain a given power output, without requiring larger overall generating system, because the blade radius is limited to the power output required by the device at any given moment. This of course must be matched precisely, using automated controls directed by a computer in consonance with the other controls required for safe, overall turbine performance.

Additionally, providing a means to vary the radius of a VAWT also allows variables such as the solidity σ (which=N*c/R, where N is the number of turbine blades, c is the blade chord length, and R is the radius of the turbine) to be altered, as the value of this variable affects the self-starting capacity of the turbine. This provides the capacity to self-start the turbine in different wind conditions by varying its solidity.

Another variable that can be affected by changing the radius is called ‘a’, which is related to the net change in wind velocity passing through a turbine over the wind velocity, a=(V₁−V₂)/V₁. By changing the value of the variable ‘a’, the amount of drag produced by the turbine as a function of power output can be altered, important for optimizing the resultant velocity of a wind-powered vehicle or vessel. This variable can be changed by reducing the energy taken from the fluid flow, by taking less for a given area, or by increasing the area by increasing a turbine radius. Lower energy harvesting changes the variable ‘a’ because it reduces the difference between the incoming and outgoing velocities.

The problem of changing the radius is more complex given the novel design of the turbine strut system. Supporting struts are used in one aspect of the invention to provide the struts with greater longitudinal rigidity, so that they can be longer than unsupported ones, which allows for a greater radius for a given set of turbine blades. A larger radius means the same blades can produce more power, as the power production is proportional to the wind-swept blade area, R*h, where R is the radius and h is the height of the blades.

One novel aspect of the variable radius turbine of the present invention is the ability to close the radius down significantly, so that it can be lowered easily at a hinge in its central axis for installation/repair/decommissioning, and also when that under extreme wind conditions, there is lower power production, and more drag inducement by the blades, as airflow over them interacts to destroy their lift-making functionality.

A second novel aspect of the present invention is to provide a means of optimizing the aerodynamic performance of a vertical wind turbine blade for whatever wind conditions exist at any moment. The present invention accomplishes this by using real-time data from sensors interpreted by intelligent software that directs servomotors to control its angle of attack and radial distance from the vertical axis.

A third novel aspect of the present invention is to provide a means of operating the VAWT at a more constant power output, to reduce the variable loading on the power train by using computer controlled feedback systems to control the variable radius. This further allows the use of smaller accumulator storage apparatus if the power take-off for the VAWT is hydraulic.

A fourth advantage of an aspect of the present invention is to allow that an increase in the radius of the turbine blades necessarily increases their height, which further increases power output as there is generally a gradient wind velocity profile at wind sites that increases with increasing height above the ground.

A fifth advantage of an aspect of the present invention is a novel geometry that closes up the turbine when it is retracted to its minimum diameter for storms or very high winds, so that it turns very little, resulting in a braking function. This capacity can be combined with a hydraulic power take-off in one embodiment, the valves of which can be closed under computer control. Thus additional shaft brakes are not required, which are generally short-lived, expensive, and costly to maintain.

A sixth advantage of an aspect of the present invention allows the VAWT blades to be at an angle off the vertical in the plane perpendicular to a line from the center of the turbine, so that helical blades can be used that minimize vibration and load variation as the VAWT revolves in a wind.

A seventh advantage of an aspect of the present invention provides a means of reducing the radius of a turbine on a yacht or ship to within such ocean vessels' beam, so that a marine vessel may dock, yet still allow open water travel with the turbine well extended past the gunnels, thus allowing greater harvesting of ocean wind energy.

An eighth advantage of an aspect of the present invention is to allow the blades to remain vertical throughout their operating range, thus providing maximum output possible for a given radius.

A ninth advantage of an aspect of the present invention is to provide greater structural support for longer struts, to increase power output with a larger maximum extension than is known in the art.

A tenth advantage of an aspect of the present invention is to allow the solidity of the turbine (the ratio of the area of the turbine blades and structure over the swept area of the turbine) to be varied by changing the radius, in order that the turbine be able to self-start which is positively correlated to the solidity, yet increase its efficiency, which is inversely correlated to the solidity.

An eleventh advantage of an aspect of the present invention is to allow the solidity to be modified in order to reduce the drag-to-power output ratio, which is critical for producing power from motor-powered vessels, where the drag must be lower than the power produced by a wind turbine for it to reduce energy consumption by the moving vessel. Reducing the solidity by increasing the radius increases the power output of a turbine, without increasing the drag. But this cannot be done without affecting the turbine's self-start capacity. Once the turbine is rotating, self-start capacity is no longer important, and thus the radius of the turbine can be extended to increase the power.

An twelfth advantage of an aspect of the present invention is to vary the hydraulic pressure on the vertical shaft of a floating wind turbine by changing the hydraulic fluid outlet pressure, so as to establish an equivalent but opposite moment on each axis, thus controlling the rotation of the platform to counteract the different moments on each turbine and the varying environmental forces. It is not important to regulate speed, which is the braking function, but to regulate torque, which will vary for each turbine blade systems on a multi-level, variable radius transverse-axis turbine, as in one embodiment of the present invention.

The device and apparatuses can be fabricated from metal, wood, plastic, ceramic, composite, or other materials as is known in the art.

### DETAILED DESCRIPTION OF THE INVENTION

The term “Tranverse-axis Turbines”, as used in the art, can refer to Vertical-Axis Wind Turbines (VAWTs), or water turbines which are tilted at an angle from vertical, or other fluid turbines where the axis is across fluid flow.

Four innovative aspects of the embodiment, the variable radius, the variable pitch, the helical blades, and its capacity to close it down substantially, are constraints on the design in the present invention, producing special aspects so that the device can deliver the desired functionality.

FIG. 1 shows one aspect of the embodiment as a VAWT, with two sets of 3 Turbine Blades 106 each having two Struts 102 attached to a Tower 108, and supported by a rotating Strut Support 104. The multiplicity of elements in this embodiment is for example only, other member numbers are possible. For instance, another embodiment of the invention might have the two independent groups of blades turn in opposite directions (with one set oriented opposite of that in FIG. 1), so as to counteract torque produced through rotation, for use on a floating body.

FIG. 1 also shows the general arrangement for this embodiment, where the Turbine Blades 106 are helical, and thus each Strut Support 104 is attached at an angle relative to the other supporting a given blade, better shown in FIG. 5. The blades require at least two struts connecting them to points on the tower so that the helical blades can furl and unfurl, where FIG. 5 shows how Struts 502 of this aspect of the embodiment attach to the Blades 506 at angles relative to the Central Axis 524 of the turbine (with the Tower removed for viewing clarity, from a top-down perspective).

Each end of the joints must have a certain number of degrees of freedom to allow the required motion of the connected parts of the device during furling and unfurling of a variable radius turbine as the radius changes.

FIG. 2 shows a 3-degree-of-freedom ball-joint, labelled 3-degree Rotational Hinge 218, at the outer end of the Struts 202, and 1-degree of freedom pin joints, labelled 1-degree Rotational Hinges 220, at the inner end of the struts, and 1-degree Rotational Hinges 220 at each of the ends of the Strut Support 204. Another aspect of the embodiment is sliding pin joints on the tower for one of the two or more struts, shown as Sliding Hinge Mount 212. These sliding mounts facilitate, by their movement up and down the axis of the Tower 208, the furling and unfurling of the turbine blades, by varying its radius. It would be possible to mount the lower hinges on the Strut Support 204 on sliding mounts to accomplish the same effect, or other possible arrangements.

The Strut Support 204 in FIG. 2 also could be replaced by a telescopic member, to provide both rotation and elongation-refraction, allowing more complete reduction of the radius, in yet another embodiment of the device.

The lengths of the Struts 202 and Strut Support 204 are related to one another, in that each of said Struts 202 must be allowed to rotate around the hinges of the Sliding Hinge Mount 212 so as to provide the necessary angular extent required to move the Turbine Blades 206 closely to the Tower 208, and also to the maximum radius designed for the transverse-axis turbine embodiment. As the hinge of one end of the Strut Support 204 is connected at a fixed point along the distance on the Struts 202, the location of this point and the length of the Strut Support 204 should allow the full range of motion of the Struts 202, given that the other end of the Strut Support 204 is a hinge fixed to the Tower 208. Determining these lengths and distances can be accomplished using geometric calculations, or by trial and error, or by using engineering software the function of which is for the development of linkages.

The Sliding Hinge Mount 212 moves up and down on a Rotating Central Axis 222 in this embodiment, although they could also travel on slides internal to the Tower 208 in another embodiment, similarly accomplishing that functionality, as two of other alternatives.

Rotating Central Axis 222 in this embodiment allows the transmission of torque to the Tower Base 210, where it can power hydraulic pumps, for instance, or electric generators, among the many power drive types. In this particular embodiment, the Rotating Central Axis 222 might have splines on it to allow the Sliding Hinge Mount 212 to transmit torque effectively, although other manners known in the art might be used to convey torque from a sliding member to a rotating shaft.

The 3-degree Rotational Hinge 218 allows motion of the blade to a limited degree for pitch control, easily accomplishing plus or minus 10 degrees of change in its angle of attack to the oncoming fluid. This occurs using a servo mechanism, Pitch Control Actuator 224, or an axial drive from the tower, or a gear motor, or other means by which the leading edge of the Turbine Blade 206 would be rotated around the 3-degree Rotational Hinge 218 substantially at an angle to the vertical axis, the 3-degree Rotational Hinge 218 is a ball joint, which can be made of stainless steel, ceramic or other material known in the art, and might mate with a socket of PTFE for instance, supported by a steel housing. Altering the diameter of the connection between the ball joint and the Turbine Blade 206 provides one means of limiting the possible change in the pitch angle, induced by an actuator.

As the direction of fluid flow changes with respect to each Turbine Blade 206 in this aspect of the embodiment, as the turbine revolves around its axis, the pitch can be altered by using sensors placed near the leading edges of each Turbine Blade 206. These sensors can send a signal indicating the pressure relative to ambient, allowing through simple algorithms the determination of the position along a portion of the cross section of the airfoil where the angle of attack would best be established, in a manner in real time, and under the direction of an automated computer control system. In this way the angle of attack, and the pitch of the blade can be optimized, even though each whole blade cannot be optimized at once everywhere, but can be optimized overall generally, owing to the different point in rotation about the center axis each section of the blade is located. This is because pitch optimization and the helical blade geometry are not easily accomplished together, but can be optimized generally as they are in a similar region of rotation. A computer algorithm that provides a summation and average optimal blade pitch would be used to accomplish this, as one possible alternative embodiment.

The Assembly and Maintenance Hinge 216 in FIG. 2 allows the rotation of the upper turbine tower, along with its blades in their refracted position, to a position where its axis is at a right angle to the ground. This aspect of the embodiment facilitates full maintenance of the turbine without requiring workers operating at great heights, exposing them to danger, which helps reduce the operating costs of the unit and maintain it more thoroughly and frequently.

The Rotating Turbine Base 214 in FIG. 2 holds one half of the Assembly and Maintenance Hinge 216, which in this embodiment would be stopped from rotating in order to disconnect the drive shaft Rotating Central Axis 222 from the power train located within Tower Base 210. Instead of incorporating a full hydraulic power system to accomplish the tower rotation, a hydraulic power system mounted on a maintenance truck would be used, reducing the cost of the turbine system.

FIG. 3 shows the operation of the Sliding Hinge Mounts 312, which are forced by hydraulics, rotating screws, or other means known in the art as powered actuators moving upward. This motion, simultaneous with that of the similar Sliding Hinge Mounts 312 on the lower Strut 302 in the diagram 3-A, causes the Turbine Blade 306 to move outwards as in the diagram 3-B, affecting the variable radius result in this aspect of the embodiment.

FIG. 4 shows that as the various dimension numbers show, when the struts of a two-strutted Turbine Blade 406 rotate about their connection to the center of the turbine, the length of the connection between each struts' ends does not remain the same. When the struts are horizontal, there is a larger distance between the outer end of the two struts than when then are more vertical.

Because the distance between the strut ends is different, either the angle of the blade must change (vertically from the sheet), or one of the center pivot points must move away from the other as the struts rotate. This aspect of the embodiment requires independent motion of the sliding hinge mounts referenced in the other figures. If they all slide together, the motion will not allow the blades to retract and extend smoothly.

Each of the parameters that govern the turbine can be identified using a Supervisory Control And Data Acquisition (SCADA) system. For instance, the radius value can be ascertained from the position of the referenced sliding hinge mounts geometrically or from a table. Thus, given their position, a signal can be sent to an actuator controlling them to move to an alternate position, on a real-time basis, thus controlling the radius dynamically to optimize the turbine's output and functional performance as wind, operational, and weather conditions change.

In a similar manner, the pitch of the blades can be ascertained from the extension of the referenced pitch control actuators, and then altered in real-time by a SCADA system to change the pitch of the referenced turbine blades, to optimize over the length of the blade generally as it rotates around the central axis of a turbine.

FIG. 6 shows an embodiment of the invention for use on a floating offshore platform, but it could equally serve on another offshore platform where torque issues were a concern. The floating device must be regulated from spinning so that it does not rotate and tangle the mooring lines, for instance, which could result in a catastrophic failure.

One aspect of this embodiment of the invention shown in FIG. 6 would be to use accelerometers as well as velocimeters as Torque Sensors to determine the actual angular velocity and acceleration of the platform. That would be the end state for comparison from which actuator signals would be sent from a SCADA system to regulate the hydraulic fluid output of each of the two turbine assemblies, the Upper Turbine Assembly 601 and the Lower Turbine Assembly 602, which in this embodiment would drive hydraulic pumps, or power-take-offs (PTOs).

Two or more counter-rotating turbine assemblies provide the offsetting power source to this aspect of a floating platform embodiment invention. The energy from each turbine assembly is transmitted via a central axis, which could be concentric about the other of the turbine system's axis.

Said Torque Sensors can be located anywhere on the VAWT where the effects of unwanted torque can be measured, such as in the Moorings 604, measuring forces on either side of each mooring. These values can then be used to alter the origin of the torque by varying the associated turbine assembly radius. For instance, if Lower Turbine Assembly 602, shown in FIG. 6 as turning counter-clockwise, where producing greater torque at its PTO than the Upper Turbine Assembly 601, there would be greater force on one side of a mooring than the other, and this force would be reflected similarly on all mooring lines at once, to distinguish it from forces due to wave action, for example. This would be resolved by reducing the radius of Lower Turbine Assembly 602, which would not imbalance the system overall otherwise. Alternatively, the radius of the Upper Turbine Assembly 601 could be increased, or a combination of these actions until the measured forces were eliminated.

In this manner, a SCADA system could keep the floating platform from turning due to the effects of greater torque on the different turbine assemblies on a real-time basis.

Alternatively, a SCADA system could affect a relief valve on one, the other, or both PTOs for each turbine assembly, raising or lowering the operating pressure of each hydraulic system. But this latter method would require two distinct hydraulic systems, suggesting that the variable radius approach is a better, less costly solution given the other benefits of a variable radius turbine device.

### BRIEF DESCRIPTION OF THE DRAWINGS

The invention is herein described, as through example only, with reference to the accompanying drawings, wherein:

FIG. 1 shows one embodiment of the invention, a VAWT with a variable radius and variable pitch, in two separate sections with 3 blades each.

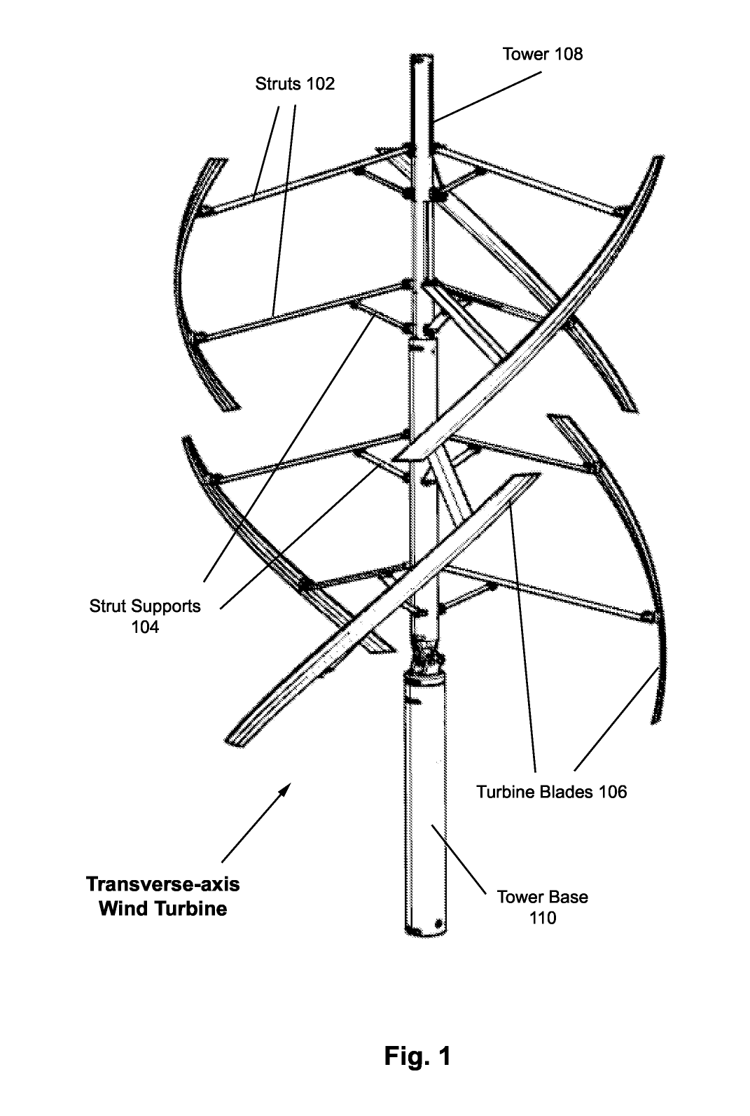

FIG. 2 is a diagram showing a close-up of a strut and blade assembly and the parts in their relations and connections to one another for an example embodiment.

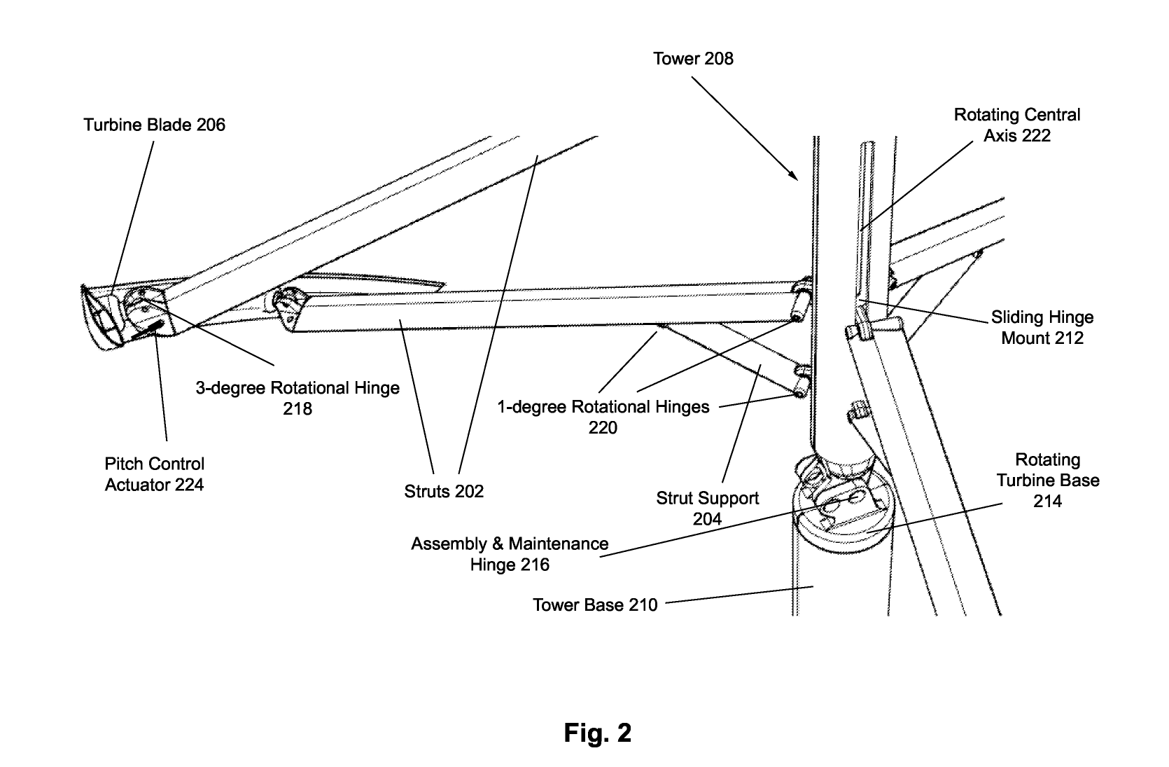

FIG. 3 shows two diagrams 3-A and 3-B of the same blade system, which is shown alone for clarity. In 3-A, the turbine blade in this embodiment is extended, and in 3-B, the turbine blade is retracted.

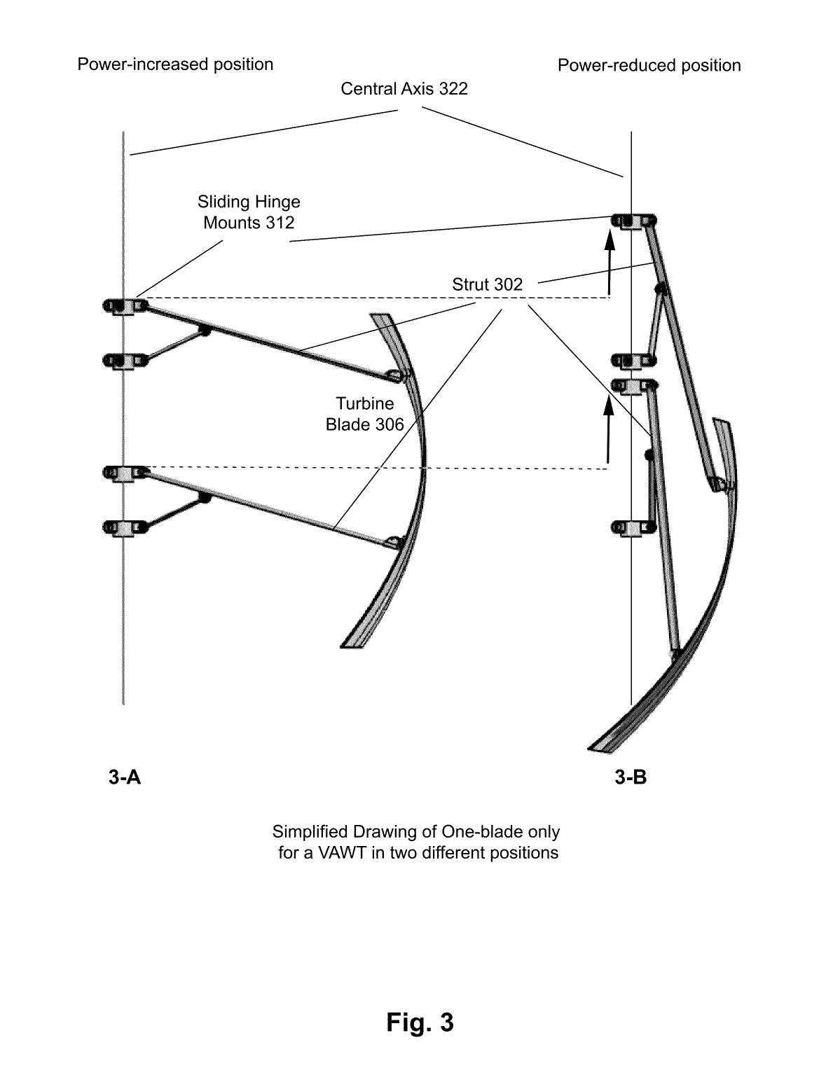

FIG. 4 shows a sketch of the calculations important for understanding how the apparatus must be constructed to allow for the variable radius helix design.

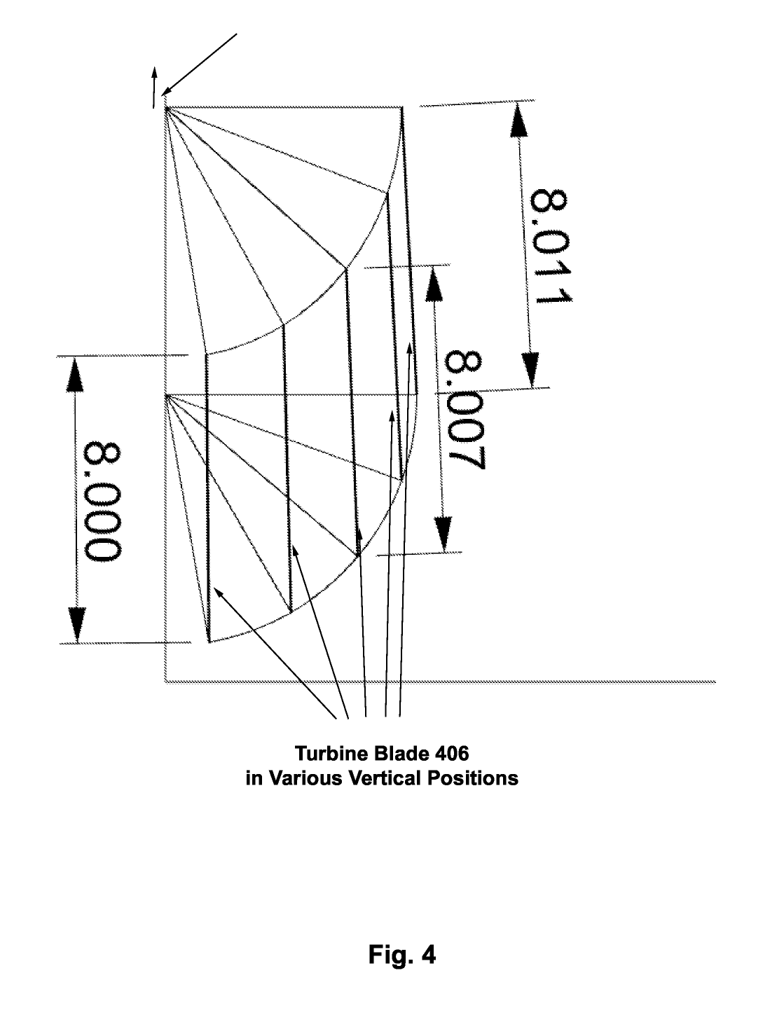

FIG. 5 shows a near top-view perspective, in order to see the relationship between the struts of a particular turbine blade in this embodiment.

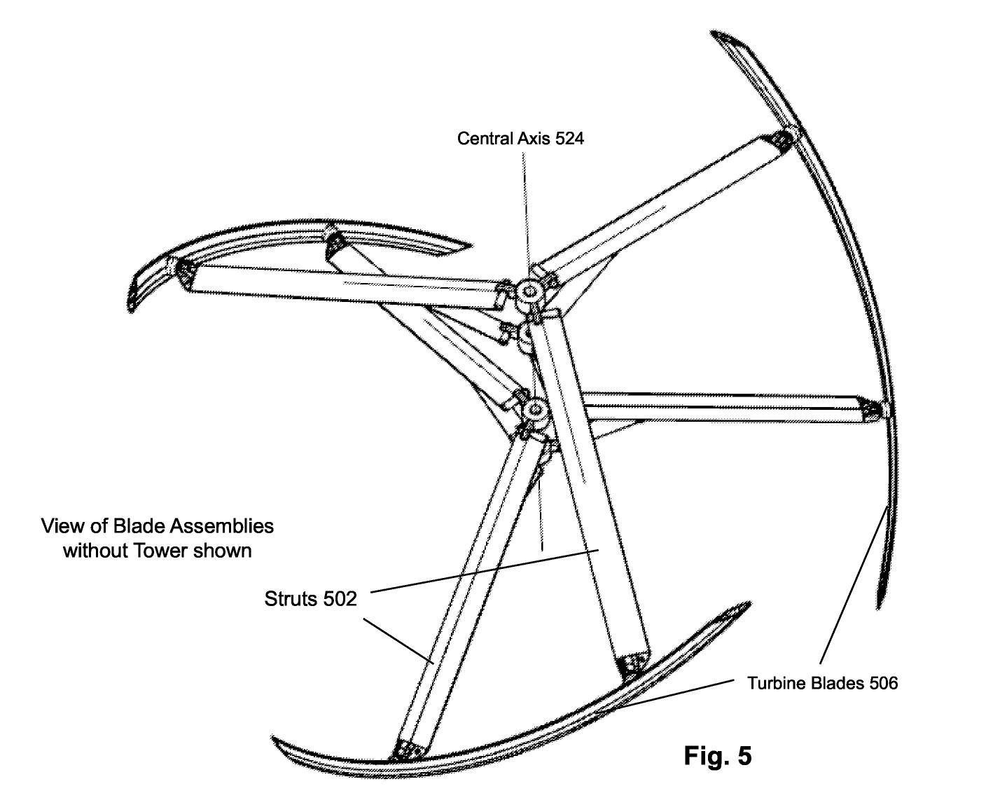

FIG. 6 shows two turbine assemblies on a floating wind platform located offshore. The embodiment described herein has as one application its use for torque balance, which is required for a floating turbine to use a VAWT.

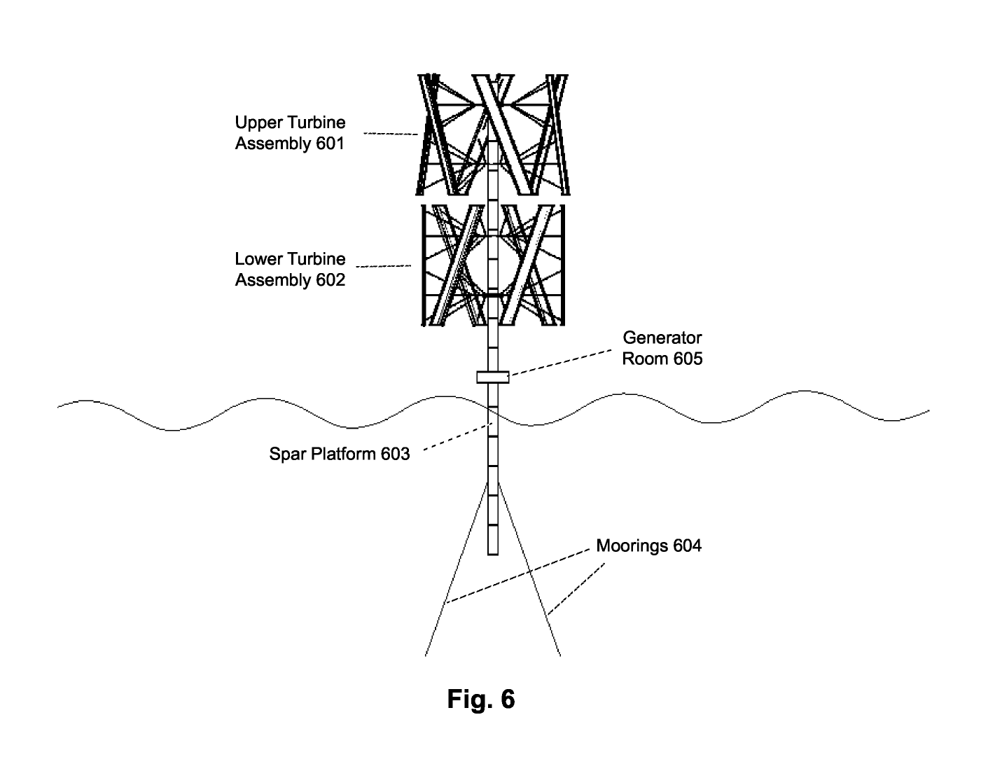

### CONCLUSIONS, RAMIFICATIONS AND SCOPE

Thus the reader can see the invention provides a means of automatically matching the power output of a turbine to various loads, such as power-fuel systems, or electricity demand. The invention also increases the possible energy harvested from a rotating transverse-axis turbine by optimizing its pitch as a helical blade travels around its central axis, generalizing the whole blade performance, rather than just one part of it.

A turbine of this design is capable to produce energy that can be stored as hydrocarbon fuels, for instance by using its energy to collect carbon dioxide from air and subsequently to convert it into fuel, thus ultimately producing carbon-neutral hydrocarbon fuel.

Other forms of the invention could be different numbers of blades, and struts per blade, or numbers of systems of blades, as alternatives to the shown example embodiment which has two distinct systems of 3 blades, shown as exemplifying a use for offshore wind turbine platforms, which in order to use VAWTs, which have a lower center of gravity, must have torque control. The systems of blades could share operating attitudes, or have different ones simultaneously, optimizing to counteract torque, for instance, or in order to make assembly easier with smaller parts, that can be transported more easily as in the case of very large turbines.

While the above description contains many specific details, these should not be construed as limitations on the scope, but rather as an exemplification of one or several embodiments thereof. Many other variations are possible.

Accordingly, the scope should be determined not be the embodiment illustrated, but by the appended claims and their legal equivalents.

What is claimed is:

1. A Transverse-Axis Turbine comprising:
A Central Axis Tower concentric to the Axis of said Transverse-Axis Turbine
One or more Turbine Blades arranged at a radial distance from said Central Axis Tower, wherein such radial distance can be altered by means of
A first Strut Assembly consisting of a Strut attached on one end to a 1-degree of freedom Sliding Hinge rotating perpendicular to and subject to forced sliding up and down said Central Axis Tower, and on the other end to a Ball Joint attached to each said Turbine Blade, and a Strut Support attached to a 1-degree of freedom Fixed Hinge rotating perpendicular to said Central Axis Tower on one end;
A second Strut Assembly similar to the first Strut Assembly, attached in a like manner to each Turbine Blade, whereby said first and second Struts can be operated in a manner that maintains said Ball Joints of said first and second Struts substantially at the same distance from the Central Axis Tower, the effect of which is to vary the radius of the turbine by varying the distance of the Turbine Blade from the Central Axis Tower;
A Power-Take-Off connected to a Rotating Central Axis in said Central Axis Tower.

2. The device of claim 1 where the Power-Take-Off is a hydraulic pump.

3. The device of claim 1 where the Power-Take-Off is an electric generator.

4. The device of claim 1 where the Power-Take-Off is a water pump.

5. The device of claims 1-4 which includes an Actuator connected to said Turbine Blade in such a manner as to allow its additional rotation about said Ball Joints, affecting the pitch or angle of attack of each Turbine Blade toward the passing fluid.

6. The device of claims 1-5 where computer software optimizes the energy production performance by adjusting the pitch and radius of said Turbine Blades, optimized to a required load or alternatively to maximum output, which utilizes a feedback system to sense the existing power output, hydraulic pressure, radius, and/or pitch and correct it to an improved state derived from historical data, wind speed, wind direction, or operational necessity.

7. The device of claims 1-6 that powers an electrical power-to-hydrocarbon fuel conversion device, utilizing carbon dioxide captured from the air through a CO2 adsorbent system and hydrogen formed by the electrolysis of water.

8. The device of claims 1-7 that includes one or more Mechanical Fans or Pumps oriented or established so as to exhaust air from the center of said Transverse-Axis Turbine, thereby reducing the internal pressure, increasing the overall efficiency of the unit, and passing said air through said CO2 adsorbent system;

9. The device of claims 1-8 which includes controlling hardware and actuators required to cause the turbine blades to affect directed attitudes and positions relative to the vertical axis, as well as feedback devices to monitor and correct such attitudes and positions.

10. Two or more of the device of claims 1-9 placed vertically separate and sharing said Central Axis Tower, rotating in opposite directions attached to a floating offshore platform, where the variable radius of the turbine is modified by the computer control system to affect a counteracting of the torque caused by said Power Take Off.

11. The device of claim 10 that utilizes a Floating Spar Buoy Platform.

12. The device of claim 10 that utilizes a Tension Leg Platform.

13. A method using a two or more coaxial variable radius transverse power turbines spinning in different rotation directions mounted on a floating offshore vessel, whereby the torque created by the sum of the torques of each of said power turbines is measured and used to automatically control the variable radius as a means of minimizing the net torque on the platform.
